(19) United States
(12) Patent Application Publication
(10) Pub. No.: US 2007/0078779 A1
(43) Pub. Date: Apr. 5, 2007

(54) Meter with notification capabilities

(76) Inventor: Roman Kresina, Oxford, CT (US)

Correspondence Address: KENYON & KENYON LLP, 1500 K STREET N.W., SUITE 700, WASHINGTON, DC, 20005, US

(21) Appl. No.: 11/243,456

(22) Filed: Oct. 4, 2005

(51) Int. Cl. G06Q 99/00

(52) U.S. Cl. 705/61

(57) ABSTRACT

A system for providing franking services is provided. The system has at least one postal meter, at least one network and at least one data center. The at least one network is connected to the postal meter. The at least one network has user interfaces. The at least one data center is connected to the at least one postal meter via the at least one network. The at least one postal meter sends a notification communication to at least one user interface on a corresponding one of the at least one network.

### BACKGROUND OF THE INVENTION

The present invention relates to a postal service meter that is capable of notifying one or more components connected to the meter.

### BRIEF DESCRIPTION OF RELATED DEVELOPMENTS

A high volume postal customer may use a meter which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

As high volumes of mail pieces are processed through the postal meters the meters may become in need of service for example, the meter may be running low on ink or postage funds. Errors in the franking process may also occur such as machine breakage, mail piece jams, etc. Where the postal meter is in a different location than the operator or user of the meter the service requirements of the meter or errors in the franking process may not be known to the operator or user.

It would be advantageous for the postal meter to have the ability to notify the data center and one or more components that are connected to the meter.

### SUMMARY OF THE EXEMPLARY EMBODIMENTS

In accordance with an exemplary embodiment, a system for providing franking services having at least one postal meter and at least one network connected to the postal meter is provided. The at least one network having user interfaces. The system also has at least one data center connected to the at least one postal meter via the at least one network. The at least one postal meter sends a notification communication to at least one user interface on a corresponding one of the at least one network.

In accordance with an exemplary embodiment, a postal meter is provided. The postal meter has a microprocessor, a storage connected to the microprocessor, an ascending register connected to the microprocessor, a descending register connected to the microprocessor and a communications port connected to the microprocessor. The microprocessor is adapted to automatically generate notification communications and send the notification communications to components connected to the meter.

### BRIEF DESCRIPTION OF THE DRAWINGS

The foregoing aspects and other features of the disclosed embodiments are explained in the following description, taken in connection with the accompanying drawings, wherein:

FIG. 1 shows a block diagram of a system suitable for practicing the exemplary embodiments; and

FIG. 2 shows a block diagram of a meter according to the exemplary embodiments.

### DETAILED DESCRIPTION OF THE EXEMPLARY EMBODIMENTS

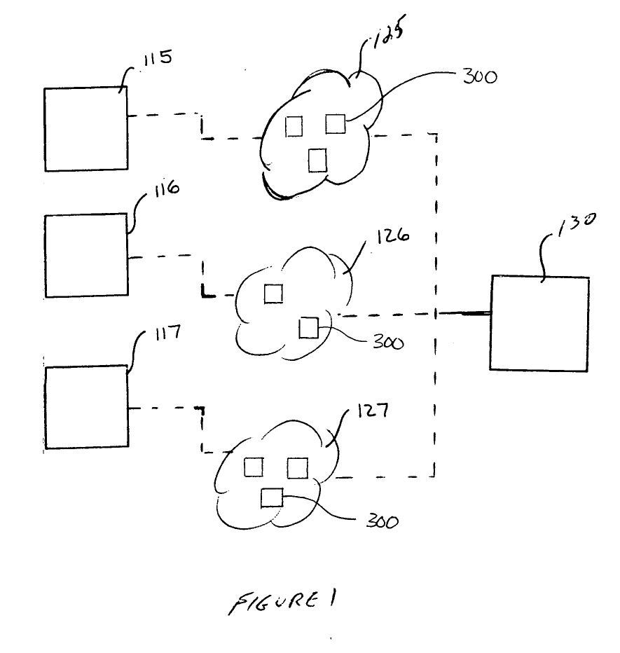

FIG. 1 shows a block diagram of a postal system 100 suitable for practicing the exemplary embodiments disclosed herein. Although the disclosed embodiments will be described with reference to the embodiments shown in the drawings, it should be understood that the disclosed embodiments can be embodied in many alternate forms of embodiments. In addition, any suitable size, shape or type of elements or materials could be used.

System 100 includes one or more funding devices, shown in FIG. 1 as postal meters 115-117. The postal meters 115-117 may be connected to a corresponding network 125-127. The networks 125-127 may each have one or more user interfaces 300, such as personal or laptop computers, personal data assistants, LED panel displays or any other suitable device that may be connected to a corresponding meter 125-127 through the network. For example, meter 115 may be connected to one or more user interfaces 300 on network 125. The meters 115-117 may also be connected to a data center 130 through its corresponding network 125-127. For example, meter 115 may be connected to the data center 130 through network 125. In alternate embodiments, there may be any number of meters connected to any number of user interfaces on any number of networks. In other alternate embodiments, there may be any number of data centers connected to the networks and meters. In yet other alternate embodiments, any suitable device may take the place of the user interfaces.

It is a feature of the exemplary embodiments for the postal meters 115-117 to initiate communication with one or more of the user interfaces 300 or the data center 130 as required.

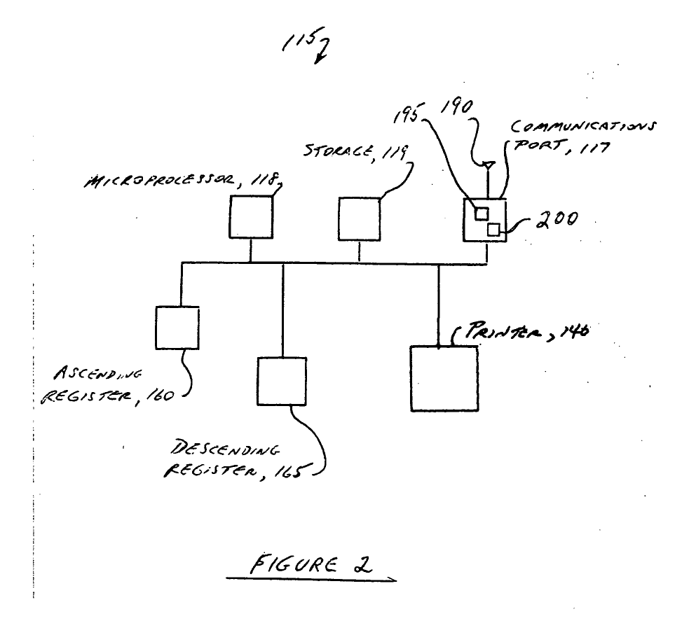

FIG. 2 shows a general block diagram of a postal meter, for example, meter 115. Meter 115 may include a communications port 117 and a microprocessor 118 for performing electronic accounting functions, control functions, and franking functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform the functions of the exemplary embodiments. Storage device 119 may utilize optical, magnetic, semiconductor, electronic, or other types of suitable devices to store the program code. Storage device 119 may contain machine readable code that is adapted to cause microprocessor 118 to automatically notify components, such as user interfaces 125-127 or the data center 130, of various events as will be described below.

Microprocessor 118 typically performs the electronic accounting functions in relation to franking items. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions performed by microprocessor 118 typically include providing an indication of postage paid, funds, or other authorization to produce indicia, and reporting the number of items, value marked and other parameters to the accounting functions. Such indication, funds, or other authorization are referred to herein as indicia services. The microprocessor 118 may also generate log files that are separate and distinct from the indicia services or other traditional record keeping functionalities of the meter as described above. The log files may contain any desired information such as for example, user actions, device failures, etc. These log files may be stored in storage 119 for retrieval by a user. As may be realized, the microprocessor 118 and meter 115 may provide a facility such as for example, a communication port for offloading the log files to any suitable storage medium such as for example, a portable computer, personal data assistant, flash memory card, etc.

The meter 115 may contain computer readable code or any other suitable circuitry so that the log files are automatically sent to a component of the system (e.g. data center 130 or user interface 300) or any other desired device connected directly to the meter such as for example, a laptop computer used by a postal authority technician. The meter may also contain a functionality such as a button, switch or other user interface that would allow the manual sending of the log files to a component on the system (e.g. data center 130 or user interface 300) or a component connected directly to the meter (e.g. a laptop computer used by a postal authority technician). These log files may also be encrypted by the microprocessor 118 or any other suitable circuitry or algorithm within the meter so that only the postal authority may gain access to the information within the log files. In alternate embodiments, the data center 130 may initiate communication with the meter 115 to retrieve the log files.

The meter 115 generally provides indicia services locally utilizing a printer 140 and may be capable of franking a label, directly franking a mail piece, or franking any other suitable substrate. Meter 115 is advantageous in that a user may place meter 115 in a specific location on or over a substrate and frank or print an object. Meter 115 may be capable of printing stamps, barcodes, addresses, planet codes, images, text, indicia, logos, graphics, or any other printable item in any desired order. For example, the user may be able to position meter 115 to print a return address, and then position meter 115 to print a mailing address, and then to print postage.

The printer 140 may be capable of printing on any suitable substrate or media, including an adhesive or tacky substrate, and may also be capable of applying a covering over the printed items. For example, the printer 140 may be capable of applying a film or coating over a printed item for protection or to prevent tampering.

The printer 140 may be an inkjet, dye sublimation, thermal wax, laser, electrostatic, xerographic, thermal, RF, or any suitable type of printer. In one embodiment, printer 140 may utilize energy beams, having high or low power, for example, RF beams, to print directly onto a substrate.

The control functions performed by microprocessor 118 may include utilizing communications port 117 to communicate with the data center 130 or corresponding user interfaces 300 on the networks 125-127. Communications port 117 generally includes an antenna 190 and support circuitry 195 or other signaling devices 200 for communicating with the data center 130 or user interfaces 300 through the one or more networks 125-127. Microprocessor 118 may also utilize communications port 117 to communicate notifications of various events concerning the postal meter 115 as will be described below.

1 The signaling devices 200 may provide an air interface, a wired interface, a wireless interface, or an electrical, electromagnetic, radio, infrared, or other suitable facility for communication. The support circuitry 195 may also include location determining circuitry, for example, a GPS facility for determining the location of the meter 115.

The data center 130 generally has the capability to access one or more of the meters 115-117 individually or simultaneously to exchange information as required. For example, the data center 130 may access meter 115 to download additional features, updates, upgrades, programs, diagnostic functions, delivery confirmation, postage funds or other types of information. The data center 130 may also access, for example, meter 115 to retrieve information including accounting data, status data, log files, notifications, etc. The user interfaces 300 may also access the meters, for example meter 115, with respect to the log files and notifications.

In one embodiment, communication between meters 115-117 and the data center 130 and/or user interfaces 300 via the networks 125-127 may be wireless. In other embodiments, the communication may occur through a combination of wireless and wired connections, or only wired connections.

Communication networks 125-127 may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc.

As noted above, microprocessor 118 may also utilize communications port 117 to communicate notifications of various events concerning the postal meter 115. The notifications may take any suitable form such as for example, email or an instant message. The notifications may be encrypted in a similar manner as described above with respect to the log files. The notifications may be generated and sent automatically to a user interface 300 on a corresponding network 125-127 or to the data center 130. Examples of notifications that may be sent to a user interface may include any suitable information such as for example, an indication that a particular job is complete, an indication that an error occurred during the franking process or that the machine is in need of service. The above notifications and any other suitable information may also be sent to the data center 130. In alternate embodiments, the data center 130 may initiate communication with meter 115 to retrieve the information regarding the various events concerning the postal meter 115.

The job completion notifications may include any suitable information such as for example, the number of pieces franked, the job's elapsed time, the total postage printed, the user name, etc. The job completion notification may be used when the postal meter, such as meter 115, is located in a separate room than the user and/or for the most part remains unattended during the franking process. The job completion notification may also be used by a user to monitor the meter's usage or job progress.

The error notifications may promptly inform a user of errors such as for example, a paper jam, a lack of ink for printing postage, low postage or any other error. The error notification may also be transferred to the data center 130 to enable the postal authority to track the types of errors that occur with the postal authority's products (e.g. postal meters). The error notifications, when received by the data center 130, may also provide the postal authority the ability to call a user or customer and inquire as to whether a service technician should be dispatched to repair the problem.

The notifications sent by the meters 115-117 may also be used, when received by the data center 130, to enable the postal authority to provide supply calls to its customers. For example, in response to a notification indicating low postage funds, low toner, etc., the postal authority may call the customer corresponding to the meter that sent the notification to inquire as to whether the customer would like to replenish the postage funds, order toner, etc. The notifications, when received by the user at the user interface 125-127, may also prompt a call from the user to the postal authority for replenishment of funds, toner, etc. In alternate embodiments, the notifications may be used to communicate any suitable information to the user interfaces or the data center or any other desired component of the postal system.

It should be understood that the foregoing description is only illustrative of the disclosed embodiments. Various alternatives and modifications can be devised by those skilled in the art without departing from the disclosed embodiments. Accordingly, the disclosed embodiments is intended to embrace all such alternatives, modifications and variances which fall within the scope of the appended claims.

What is claimed is:

1. A system for providing franking services comprising:
at least one postal meter;
at least one network connected to the postal meter, the at least one network having user interfaces; and
at least one data center connected to the at least one postal meter via the at least one network;
wherein the at least one postal meter automatically sends a notification communication to at least one user interface on a corresponding one of the at least one network.

2. The system of claim 1, wherein at least one postal meter automatically sends a notification communication to the at least one data center.

3. The system of claim 1, wherein the notification communication is an email.

4. The system of claim 1, wherein the notification communication is encrypted.

5. The system of claim 1, wherein the at least one postal meter is adapted to store log files.

6. The system of claim 5, wherein the at least one postal meter is adapted to offload the log files to a storage device connected directly to the at least one postal meter.

7. The system of claim 5, wherein the log files are automatically sent to at least one user interface on a corresponding one of the at least one network and/or the at least one data center.

8. The system of claim 5, wherein the log files are manually sent to at least one user interface on a corresponding one of the at least one network and/or the at least one data center in response to an operator action.

9. The system of claim 5, wherein the log files are encrypted.

10. A postal meter comprising:
a microprocessor;
a storage connected to the microprocessor;
an ascending register connected to the microprocessor;
a descending register connected to the microprocessor; and
a communications port connected to the microprocessor;
wherein the microprocessor is adapted to automatically generate notification communications and send the notification communications to components connected to the meter.

11. The postal meter of claim 10, wherein the microprocessor is further adapted to generate log files, the log files being stored in the storage after they are generated.

12. The postal meter of claim 10, wherein the notification communications are encrypted.

13. The postal meter of claim 11, wherein the log files are encrypted.
